(19) United States
(12) Patent Application Publication
(10) Pub. No.: US 2018/0201193 A1
(43) Pub. Date: Jul. 19, 2018

(54) REAR VIEWING DEVICE

(71) Applicant: KABUSHIKI KAISHA HONDA LOCK, Miyazaki-shi, Miyazaki (JP)

(72) Inventor: Hiroshi SAKAMOTO, Miyazaki (JP)

(21) Appl. No.: 15/744,224

(22) PCT Filed: Apr. 21, 2016
(86) PCT No.: PCT/JP2016/062582

§ 371 Date: Jan. 12, 2018

(30) Foreign Application Priority Data
Jul. 23, 2015 (JP) 2015-146018

(51) Int. Cl. B60R 1/12; B60R 1/04

(52) U.S. Cl. CPC B60R 1/12; B60R 2001/1215; B60R 1/04

(57) ABSTRACT

Provided is a rear viewing device capable of improving visibility of a forward view or rearward view while realizing improvement of operability and restraint of contact with a passenger. The rear viewing device includes a monitor 21 configured to display a video of a rearward view of a vehicle 1 captured by a rear camera, a mirror 22 configured to reflect the video of the rearward view displayed on the monitor 21, and a housing 23 provided on a roof 11 of an interior C of the vehicle and storing at least the mirror 22. The housing 23 has an opening 42 for emitting the video of the rearward view reflected by the mirror 22 toward the interior C of the vehicle.

### TECHNICAL FIELD

This application claims priority from Japanese Patent Application No. 2015-146018 filed on Jul. 23, 2015 with the Japan Patent Office the entire contents of which are hereby incorporated by reference.

The present invention relates to a rear viewing device.

### BACKGROUND ART

A room mirror, which is one of rear viewing devices of vehicles, includes a stay projected from a windshield or a front end portion of a roof and a mirror provided at a tip portion of the stay. A room mirror of this kind is arranged between a driver and the windshield. Therefore, a part of a forward view overlapped by the room mirror is a blind spot. In view of this, for example, Patent Literature 1 cited below discloses a configuration in which a room mirror is arranged at a position that does not overlap a forward view of a driver.

Further, in the room mirror, a rearward view of a vehicle is blocked depending on a riding state of a passenger who sits in a back seat, a loading state of a baggage loaded in an interior of the vehicle, or the like in some cases. In view of this, there has recently been known, as one of rear viewing devices, a configuration for allowing a video of a rearward view of a vehicle captured by a camera to be visually recognized by using a monitor installed in an interior of the vehicle (for example, see Patent Literatures 1 to 3 below).

In particular, configurations disclosed in Patent Literatures 2 and 3 below cause a mirror to reflect a video of a rearward view displayed by a monitor, thereby allowing a driver to visually recognize the video. With the above configurations, it is possible to increase a focal distance of a driver obtained when the driver views the monitor via the mirror, as compared to a focal distance of the driver obtained when the driver directly views the monitor. Therefore, it is possible to reduce a difference between the focal distance of the driver obtained when the driver views the monitor via the mirror and a focal distance of the driver obtained when the driver views outside of a vehicle (for example, forward view). It is therefore considered that it is possible to reduce a burden on eyes of the driver caused by viewpoint movement of the driver.

### CITATION LIST

### Patent Literature

Patent Literature 1: JP-A-2001-315576

Patent Literature 2: JP-A-2009-120080

Patent Literature 3: JP-T-2009-542505

### SUMMARY OF THE INVENTION

### Problems to be Solved by the Invention

However, in the above-mentioned configuration in Patent Literature 1, the room mirror is arranged at a position that does not overlap a forward view of a driver. Therefore, an installing position of the room mirror is set at a higher position than a position of a typical room mirror. In this case, in order to visually recognize a rearward view of the vehicle by using the room mirror, it is necessary to set an angle of the room mirror downward, as compared to a typical room mirror. When the room mirror is set downward, a visual range of the room mirror approaches an area near a rear portion of the vehicle. Therefore, there is a possibility that a rearward view of an area far from the rear portion of the vehicle cannot be visually recognized. In this case, it is problematic in that, when the visual range is attempted to be widened to the area far from the rear portion of the vehicle in a state in which the angle of the room mirror is directed downward, a vehicle design, such as shapes of a rear body and rear glass, is restricted.

The configurations in Patent Literatures 2 and 3 can switch between a mode in which a rearward view is directly visually recognized via the mirror and a mode in which a video of the rearward view displayed on the monitor is visually recognized via the mirror. Therefore, it is necessary to change an angle of the mirror in accordance with each mode. It is therefore problematic in that operation of the mirror is complicated.

Further, in the configurations of Patent Literatures 2 and 3, it is necessary to arrange the mirror at a position at which the rearward view of the vehicle can be visually recognized. Therefore, a passenger may, for example, touch the mirror at the time of getting on or off the vehicle.

Furthermore, in the configurations in Patent Literatures 2 and 3, the mirror is arranged at a position at which the rearward view of the vehicle can be directly visually recognized. Therefore, light from outside (for example, sunlight or light emitted from a surrounding vehicle or the like) may be reflected by the mirror, thereby obstructing visibility of the mirror.

In view of this, the present invention has been made in view of such a circumstance. An object of the present invention is to provide the following rear viewing device. This rear viewing device can improve visibility of a forward view or rearward view while realizing improvement of operability and restraint of contact with a passenger.

### Solutions to the Problems

A rear viewing device of the present invention employs the following configurations.

(1) The rear viewing device includes: an image output unit configured to output an image of a rearward view of a vehicle captured by an image capturing unit; a reflector configured to reflect the image of the rearward view output from the image output unit; and a storage portion provided on a roof of an interior of the vehicle and storing at least the reflector, in which the storage portion has an opening for emitting the image of the rearward view reflected by the reflector toward the interior of the vehicle.

With this configuration, the image of the rearward view displayed on the image output unit is reflected by the reflector and is then emitted toward the interior of the vehicle through the opening. Thus, a driver can visually recognize the image of the rearward view output from the image output unit via the reflector. Therefore, even in a case where the rearward view of the vehicle is blocked depending on a riding state, a loading state, or the like, it is possible to obtain favorable rearward visibility.

In particular, the reflector is stored in the storage portion provided on the roof. Therefore, the reflector is used only to reflect the image of the rearward view output from the image output unit. It is therefore unnecessary to change an angle of the reflector in accordance with each mode, which is different from a typical configuration having a mode in which the rearward view of the vehicle is directly reflected and a mode in which the image of the rearward view output from the image output unit is reflected. Therefore, it is possible to improve operability.

Further, because the reflector is used only to reflect the image of the rearward view output from the image output unit, favorable rearward visibility is obtained, and, in addition, a degree of freedom of an installing position of the rear viewing device (reflector) is improved, and there is no possibility of restricting a vehicle design. In this case, for example, when the rear viewing device is installed as high as possible, it is possible to reduce a part where the rear viewing device overlaps a forward view of the driver. Therefore, it is possible to improve forward visibility. Furthermore, it is possible to restrain a projection amount toward the interior of the vehicle from the roof and a windshield. Therefore, it is possible to restrain a passenger from, for example, touching the rear viewing device (reflector) at the time of, for example, getting on and off the vehicle. Further, because the reflector is stored in the storage portion, it is possible to restrain light from outside from being incident on the reflector. It is therefore possible to favorably maintain visibility of the reflector, regardless of an external situation.

(2) In the rear viewing device in the aspect (1), the storage portion may block a space between the reflector and a rear panel of the vehicle.

With this configuration, the space between the reflector and the rear panel (for example, rear glass) is blocked by the storage portion. Therefore, it is possible to restrain the rearward view of the vehicle from being directly visually recognized via the reflector. Thus, it is possible to improve operability and restrain the rearward view from being mistakenly recognized via the reflector.

(3) In the rear viewing device in the aspect (1) or (2), the image output unit may be a monitor for displaying the image of the rearward view, and the reflector may be a mirror for reflecting the image of the rearward view displayed on the image output unit.

With this configuration, the image of the rearward view displayed on the monitor serving as the image output unit is reflected by the mirror serving as the reflector. Thus, it is possible to increase a distance between an eye-point of the driver and the monitor (focal distance of the driver obtained when the driver views the rear viewing device), as compared to a configuration in which the monitor is directly visually recognized. Thus, it is possible to reduce a difference between a focal distance obtained when the driver views the rearward view of the vehicle via the rear viewing device and a focal distance obtained when the driver views outside of the vehicle. Therefore, it is possible to reduce time to perform focus adjustment of the driver caused by viewpoint movement of the driver. As a result, it is possible to reduce a burden on eyes of the driver.

(4) In the rear viewing device in any one of the aspects (1) to (3), the image output unit may be stored in the storage portion together with the reflector.

With this configuration, the image output unit and the reflector are stored in the storage portion and are unitized. Therefore, it is unnecessary to adjust a relative position of the image output unit and the reflector at the time of attachment to the vehicle. It is therefore possible to improve assemblability of the rear viewing device into the vehicle.

(5) In the rear viewing device in any one of the aspects (1) to (4), the reflector may have a concave reflection surface.

With this configuration, an apparent distance between the reflector and the image output unit, which is obtained when the driver views the reflector, can be increased, as compared to an actual distance. Thus, it is possible to reduce a difference between a focal distance obtained when the driver views the rearward view via the rear viewing device and a focal distance obtained when the driver views outside of the vehicle. Therefore, it is possible to reduce time to perform focus adjustment of the driver caused by viewpoint movement of the driver. As a result, it is possible to reduce a burden on the eyes of the driver.

(6) The rear viewing device in any one of the aspects (1) to (5) may have a divided screen mode in which the image of the rearward view is displayed on an upper portion of the reflector or the image output unit and a whole screen mode in which the image of the rearward view is displayed on the whole reflector or the whole image output unit.

With this configuration, for example, in a case where an existing image output unit (or reflector) having an aspect ratio of 16:9 is used, the divided screen mode is set in a range other than a reverse position (R), and therefore it is possible to display a video of the rearward view at an aspect ratio equivalent to that of an existing mirror (mirror whose longitudinal direction is a vehicle width direction). Thus, it is possible to reduce discomfort of the driver while reducing costs.

On the contrary, for example, when the whole screen mode is set in a case where the range is in the reverse position (R), a wide range of the rearward view of the vehicle including an area near a rear portion of the vehicle can be visually recognized when the vehicle moves backward.

### Effects of the Invention

According to the present invention, it is possible to improve visibility of a forward view or rearward view while realizing improvement of operability and restraint of contact with a passenger.

### BRIEF DESCRIPTION OF THE DRAWINGS

FIG. 1 is a schematic configuration view (side surface view) of a vehicle including a rear viewing device according to an embodiment.

FIG. 2 is a perspective view of an interior of a vehicle including a rear viewing device according to an embodiment, which is seen from a back side.

FIG. 3 is a cross-sectional view taken along line III-III of FIG. 2.

FIG. 4 is a front view of a monitor in a divided screen mode.

FIG. 5 is a front view of a monitor in a whole screen mode.

FIG. 6 is a cross-sectional view of a rear viewing device according to a second embodiment.

### DESCRIPTION OF EMBODIMENTS

Embodiments of the present invention will be described with reference to the drawings. Directions such as forward and backward, vertical, and horizontal directions in the following direction are the same as directions of the vehicle, unless otherwise noted. Further, an arrow UP in the drawings indicates an upward direction, and an arrow FR indicates a forward direction.

### First Embodiment

[Vehicle]

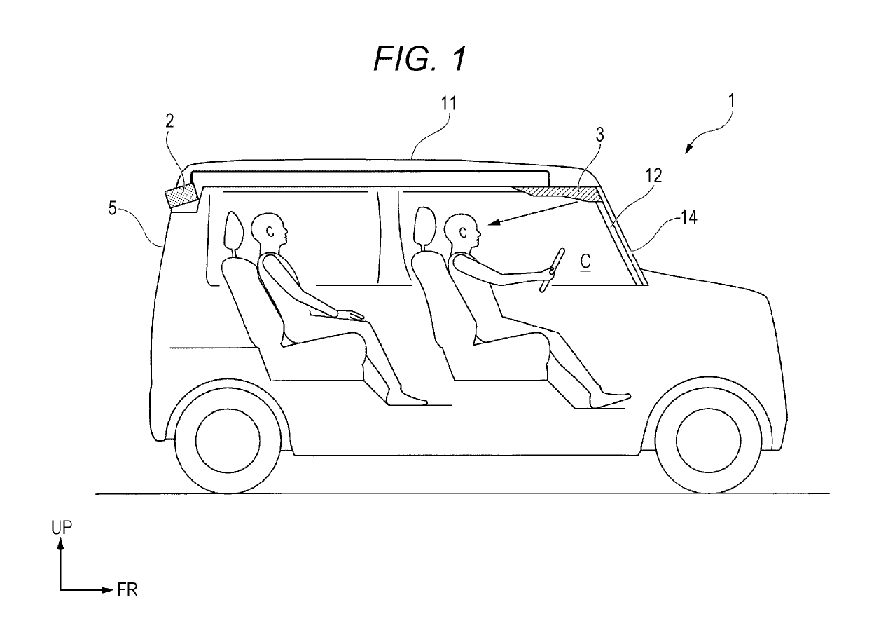

FIG. 1 is a schematic configuration view (side surface view) of a vehicle 1 including a rear viewing device 3.

The vehicle 1 illustrated in FIG. 1 includes a rear camera (image capturing unit) 2 for capturing an image of a rearward area of the vehicle 1 and the rear viewing device 3. The rear viewing device 3 visually recognizes a rearward view of the vehicle 1 based on a video of a rearward view captured by the rear camera 2.

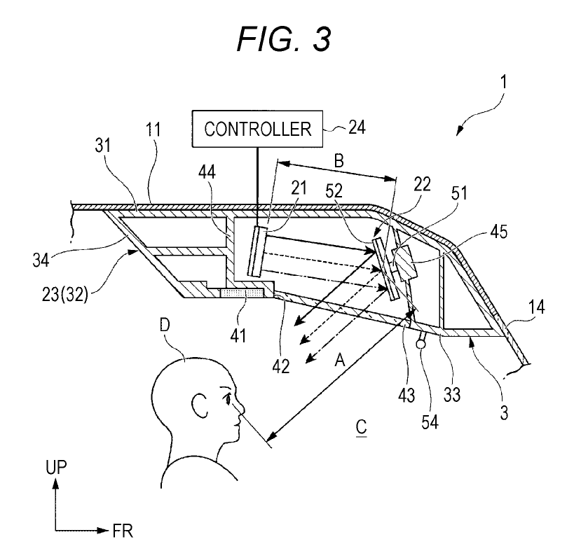

The rear camera 2 is installed in a rear portion of the vehicle 1 (for example, tailgate 5). The rear camera 2 outputs data of the captured video of the rearward view to a controller 24 described below (see FIG. 3). Note that, as the rear camera, for example, a digital camera including a solid-state imaging element such as a CCD (Charge Coupled Device) or a CMOS (Complementary Metal Oxide Semiconductor) is suitably used. Further, it is possible to appropriately change a design of an installing position of the rear camera.

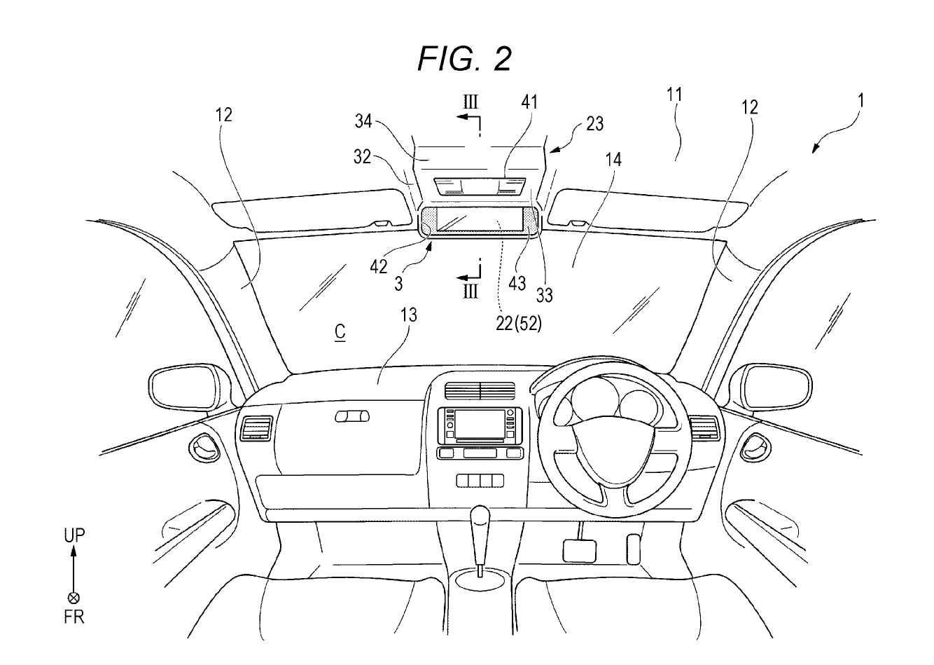

FIG. 2 is a perspective view of an interior C of the vehicle, which is seen from a back side.

As illustrated in FIG. 2, the vehicle 1 includes a roof 11, front pillars 12, an instrument panel 13, and a windshield 14.

The roof 11 forms an upper portion of the interior C of the vehicle.

The front pillars 12 extend forward from both end portions in a vehicle width direction of the roof 11 toward lower portions.

The instrument panel 13 forms a front portion of the interior C of the vehicle. Lower end portions of the above-mentioned front pillars 12 are connected to both end portions in the vehicle width direction of the instrument panel 13, respectively.

The windshield 14 covers an opening defined by a front edge of the above-mentioned roof 11, inner edges in the vehicle width direction of the front pillars 12, and a front edge of the instrument panel 13.

<Rear Viewing Device>

FIG. 3 is a cross-sectional view taken along line of FIG. 2.

As illustrated in FIG. 3, the rear viewing device 3 is provided at a center portion in the vehicle width direction of a front end portion of the roof 11. The rear viewing device 3 includes a monitor (image output unit) 21, a mirror (reflector) 22, a housing (storage portion) 23 storing the monitor 21 and the mirror 22, and the controller 24.

The housing 23 is made of a material having a light-shielding property. The housing 23 has an attachment wall portion 31 attached to the roof 11, a side wall portion 32, and a lower wall portion 33. The side wall portion 32 is provided to extend downward from a circumferential edge of the attachment wall portion 31. The lower wall portion 33 is connected to a lower edge of the side wall portion 32.

The attachment wall portion 31 is provided along a lower surface shape (roof lining) of the roof 11. In the example of FIG. 3, a rear portion of the attachment wall portion 31 is linearly provided to extend in a forward and backward direction in a cross-sectional view seen from the vehicle width direction. A front portion of the attachment wall portion 31 is extended while being curved downward toward the front in the cross-sectional view seen from the vehicle width direction. Note that a front end portion of the attachment wall portion 31 is provided to extend along an inner surface of the windshield 14. In the example in FIG. 3, a front edge of the attachment wall portion 31 is positioned below an upper edge of the windshield 14.

The side wall portion 32 surrounds both sides in the vehicle width direction and a back side of the attachment wall portion 31. A rear wall portion 34 of the side wall portion 32, which is connected to a rear edge of the attachment wall portion 31, is inclined forward toward a lower portion.

Both end portions in the forward and backward direction of the lower wall portion 33 are linearly provided to extend in the forward and backward direction in the cross-sectional view seen from the vehicle width direction. A room light 41 that illuminates the interior C of the vehicle is installed in a rear end portion of the lower wall portion 33. A center portion in the forward and backward direction of the lower wall portion 33 is inclined downward toward the front. An opening 42 penetrating the lower wall portion 33 in the vertical direction is provided at the center portion in the forward and backward direction of the lower wall portion 33. The lens 43 is provided in the opening 42. The lens 43 is made of a material having a light-transmitting property (for example, glass or resin material). Therefore, a driver D can visually recognize inside of the housing 23 through the lens 43.

A monitor support wall 44 is provided on a part of the lower wall portion 33, the part being positioned behind the opening 42. The monitor support wall 44 is erected upward from the lower wall portion 33. An upper end portion of the monitor support wall 44 is connected to the attachment wall portion 31.

A mirror support wall 45 is provided on a part of the lower wall portion 33, the part being positioned to face (ahead of) the monitor support wall 44 via the opening 42. The mirror support wall 45 is erected upward from the lower wall portion 33. An upper end portion of the mirror support wall 45 is connected to the attachment wall portion 31. Note that, in the example in FIG. 3, a lower end portion of the mirror support wall 45 is connected to a front opening edge of the opening 42 of the lower wall portion 33. Note that the mirror support wall 45 only needs to be provided on a part positioned ahead of the opening 42 in the housing 23.

The monitor 21 is attached to the above-mentioned monitor support wall 44 of the housing 23 via a bracket (not shown) and the like in a state in which a display surface is directed forward. Note that the monitor 21 may be attached to the attachment wall portion 31, the side wall portion 32, the lower wall portion 33, or the like. In the example in FIG. 3, the monitor 21 is slightly inclined downward. The monitor 21 is made up of, for example, a liquid crystal display or organic EL display having an aspect ratio of 16:9.

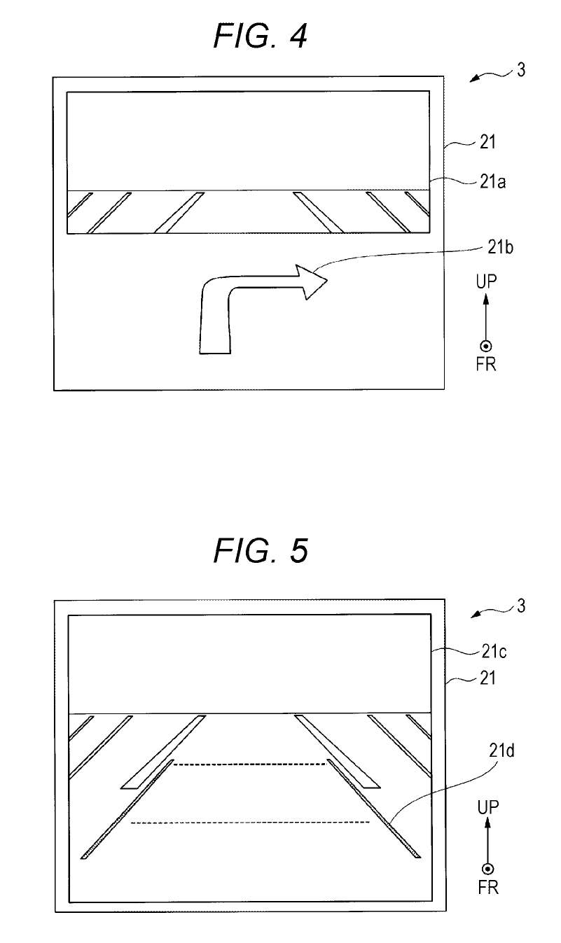

FIG. 4 is a front view of the monitor 21 in a divided screen mode. FIG. 5 is a front view of the monitor in a whole screen mode.

The rear viewing device 3 in this embodiment has the divided screen mode illustrated in FIG. 4 and the whole screen mode illustrated in FIG. 5.

In the divided screen mode illustrated in FIG. 4, a video 21a of the rearward view captured by the above-mentioned rear camera 2 is displayed on an upper half portion of the monitor 21, and vehicle information 21b is displayed on a lower half portion of the monitor 21. Note that it is possible to employ, as the vehicle information 21b, driving information of the vehicle 1 such as a driving speed, a rotational speed, and a driving distance, route guide information of a navigation device (not shown), passenger monitor information by an in-vehicle camera (not shown), and vehicle peripheral information obtained by a front camera, a radar, or the like (not shown) (in the example illustrated in the figure, route guide information is displayed). Note that, in the divided screen mode, a display region of the video 21a of the rearward view only needs to fall within a range of ¼ to ¾ of the monitor 21 from an upper edge thereof.

In the whole screen mode illustrated in FIG. 5, a video 21c of the rearward view obtained by the above-mentioned rear camera 2 is displayed on the whole monitor 21. Note that a reference sign 21d in FIG. 5 indicates a guide line displayed while being superimposed on the video 21c of the rearward view. The guide line 21d indicates a direction, a vehicle width, and a sense of distance of the vehicle 1.

As illustrated in FIG. 3, the mirror 22 includes a stay 51 provided on the mirror support wall 45, a mirror main body 52 that is connected to the stay 51 so as to be swingable, and a mirror adjuster 53 for adjusting an angle of the mirror main body 52.

The stay 51 is provided on the mirror support wall 45 to be projected backward from the mirror support wall 45. In the example in FIG. 3, the stay 51 is inclined downward toward a lower portion. Note that a rear end portion of the stay 51 forms a joint portion (not shown) having, for example, a spherical shape.

The mirror main body 52 faces the monitor 21 on an optical path thereof (forward and backward direction). The mirror main body 52 reflects a video displayed on the monitor 21 in a diagonally downward and backward direction. The mirror main body 52 is connected to the joint portion of the stay 51 in a state in which a reflection surface thereof is directed backward. Thus, the mirror main body 52 swings (sways) while the center of the joint portion serves as a fulcrum. Note that the mirror main body 52 is provided so that an external shape of the reflection surface is equal to an external shape of the display surface of the monitor 21. Note that it is possible to appropriately change a size of the mirror main body 52.

The mirror main body 52 is stored in the housing 23 and is therefore configured to be visually recognized from the interior C of the vehicle only through the opening 42. Further, the mirror main body 52 is positioned above the lower wall portion 33 of the housing 23. Furthermore, the mirror main body 52 overlaps the monitor support wall 44 and the rear wall portion 34 of the housing 23 when the rear viewing device 3 is seen from a back side. That is, a space between the mirror main body 52 and rear glass (not shown) is blocked by the housing 23, and the rear glass is a blind spot. Note that the mirror main body 52 only needs to be arranged in the housing 23 at a position at which the interior C of the vehicle does not appear in a mirror image seen by the driver D through the opening 42. In this case, for example, the mirror main body 52 only needs to be provided at a position at which the rear panel (for example, the above-mentioned rear glass, a rear hatch, and the tailgate 5) which forms a rear wall of the vehicle 1 is not directly visually recognized as a mirror image. Note that, in the example in FIG. 3, the mirror main body 52 is positioned above the above-mentioned upper edge of the windshield 14.

Herein, it is assumed that a distance between the mirror main body 52 and an eye-point of the driver D is A (mm) and a distance between the mirror main body 52 and the monitor 21 is B (mm). In this case, a focal distance (distance connecting the monitor 21 and the eye-point of the driver D via the mirror main body 52) F of the driver D obtained when the driver D views the rear viewing device 3 is A+B. In this embodiment, A and B are preferably set so that the focal distance F of the driver D is 700 (mm) or more (F=A+B≥700). In this case, it is possible to appropriately change sizes of A and B.

The mirror adjuster 53 includes an operation lever 54 and a swinging mechanism (not shown) connecting the mirror main body 52 and the operation lever 54.

The operation lever 54 is provided on a part of the lower wall portion 33, the part being positioned ahead of the opening 42, so as to be projected downward. The operation lever 54 is configured to be tiltable in the forward and backward direction and the horizontal direction. Note that it is possible to appropriately adjust an installing position of the operation lever 54. In this case, the operation lever 54 may be installed in the instrument panel 13, a door trim, or the like.

The swinging mechanism swings the mirror main body 52 in accordance with tilting operation of the operation lever 54. Note that the swinging mechanism may be configured so that the mirror main body 52 and the operation lever 54 are connected via a wire, a link, or the like to operate the mirror main body 52 in conjunction with tilting operation of the operation lever 54. Further, the swinging mechanism may be configured so that the mirror main body 52 is swung by driving a drive source such as a motor in accordance with tilting operation of the operation lever 54.

The controller 24 is configured by mounting an electronic circuit unit on a control board. The electronic circuit unit includes, for example, a CPU, a RAM, a ROM, and an interface circuit.

The controller 24 generates video data for display (for example, data obtained by horizontally inverting data of a video of the rearward view) based on data of a video of the rearward view output from the rear camera 2.

Further, the controller 24 generates vehicle data for display based on data output from the navigation device, the front camera, the radar, and the like.

The controller 24 switches between the above-mentioned divided screen mode and the whole screen mode in accordance with a range of an automatic transmission (not shown). Specifically, the controller 24 determines whether or not the range is in a reverse position (R). In a case where the controller 24 determines that the range is in the reverse position (R), the controller 24 selects the whole screen mode. On the contrary, in a case where the controller 24 determines that the range is not in the reverse position (R) (for example, parking position (P) or drive position (D)), the controller 24 selects the divided screen mode.

In the whole screen mode illustrated in FIG. 5, the controller 24 outputs the above-mentioned video data for display to the monitor 21 as whole-screen data.

Meanwhile, in the divided screen mode illustrated in FIG. 4, the controller 24 outputs, to the monitor 21, divided-screen data in which a part of the above-mentioned video data for display (in the example in FIG. 4, an upper half portion of the whole-screen data) and the vehicle data for display are combined.

Next, effects of the above-mentioned rear viewing device 3 will be described.

First, as illustrated in FIG. 3, when the operation lever is tilted, the mirror main body 52 is swung at an angle at which the driver D can visually recognize a video displayed on the monitor 21. Then, in a case where the range of the automatic transmission is in a position other than the reverse position (R), a video for the divided screen mode is displayed on the monitor 21. Specifically, as illustrated in FIG. 4, the video of the rearward view captured by the rear camera 2 as mentioned above is displayed on the upper half portion of the monitor 21, and the vehicle information is displayed on the lower half portion of the monitor 21.

As illustrated in FIG. 3, the video displayed on the monitor 21 is emitted forward, is reflected by the mirror main body 52, and is then emitted toward the interior C of the vehicle through the lens 43. Thus, the driver D can visually recognize the video displayed on the monitor 21 via the mirror main body 52.

On the contrary, in a case where the range of the automatic transmission is in the reverse position (R), a video for the whole screen mode is displayed on the monitor 21. Specifically, as illustrated in FIG. 5, the video of the rearward view captured by the rear camera 2 is displayed on the whole monitor 21. Note that the video displayed on the monitor 21 as mentioned above is reflected by the mirror main body 52 and is then emitted toward the interior C of the vehicle through the lens 43 in the same way as in the above-mentioned divided screen mode. Thus, the driver D can visually recognize the video displayed on the monitor 21 via the mirror main body 52.

By the way, as mentioned above, in a typical room mirror, a rearward view of a vehicle is blocked in some cases depending on, for example, a riding state of a passenger who sits in a back seat (for example, when a passenger sits between a room mirror and rear glass) or a loading state of a baggage loaded in an interior of the vehicle (for example, when a baggage is loaded at a height at which a space between the room mirror and the rear glass is blocked).

In view of this, in this embodiment, a video of the rearward view of the vehicle 1, which is captured by the rear camera 2 installed in the rear portion of the vehicle 1, is displayed on the monitor 21. This makes it possible to visually recognize the video of the rearward view displayed on the monitor 21 via the mirror main body 52. Therefore, even in a case where the rearward view of the vehicle 1 is blocked depending on the riding state, the loading state, or the like, it is possible to obtain favorable rearward visibility.

In particular, in this embodiment, the mirror 22 is stored in the housing 23 attached to the roof 11. Therefore, the mirror 22 is used only to reflect a video displayed on the monitor 21. It is therefore unnecessary to change an angle of the mirror in accordance with each mode, which is different from a typical configuration having a mode in which the rearward view of the vehicle is directly reflected and a mode in which a video of the rearward view displayed on a monitor is reflected. Therefore, it is possible to improve operability.

Further, in order to improve forward visibility and prevent, for example, contact with a passenger at the time of getting on and off the vehicle, the mirror is preferably installed as high as possible (for example, above an inner surface of the roof). However, as mentioned above, in the typical room mirror, there is a possibility that the rearward view of the vehicle through the rear glass cannot be visually recognized by a driver depending on a relative position of the driver, the room mirror, and the rear glass. Even if the rearward view of the vehicle can be visually recognized, it is necessary to set an angle of the room mirror downward. When the room mirror is set downward, a visual range of the room mirror approaches an area near a rear portion of the vehicle. Therefore, there is a possibility that a rearward view of an area far from the rear portion of the vehicle cannot be visually recognized. In this case, it is problematic in that, when the visual range is attempted to be widened to the area far from the rear portion of the vehicle in a state in which the angle of the room mirror is directed downward, a vehicle design, such as shapes of the rear body and the rear glass, is restricted.

Meanwhile, in this embodiment, the mirror 22 is used only to reflect a video displayed on the monitor 21. Thus, favorable rearward visibility is obtained, and, in addition, a degree of freedom of the installing position of the rear viewing device 3 (mirror 22) is improved, and there is no possibility of restricting a vehicle design. In this case, for example, when the rear viewing device 3 is installed as high as possible, it is possible to reduce a part where the rear viewing device 3 overlaps a forward view of the driver D. Therefore, it is possible to improve forward visibility. Furthermore, it is possible to restrain a projection amount toward the interior C of the vehicle from the roof 11 and the windshield 14. Therefore, it is possible to restrain a passenger from, for example, touching the rear viewing device 3 (mirror 22) at the time of, for example, getting on and off the vehicle. Further, the mirror 22 is stored in the housing 23, and therefore it is possible to restrain light from outside from being incident on the mirror main body 52. It is therefore possible to favorably maintain visibility of the mirror main body 52, regardless of an external situation.

Herein, even if the rearward view of the vehicle is visually recognized by using the mirror through the rear glass, there is a possibility of wrongly recognizing whether a mirror image reflected by the mirror is a rearward view or a video of the rearward view displayed on the monitor.

In view of this, in this embodiment, the space between the mirror 22 and the rear glass is blocked by the housing 23. Therefore, it is possible to restrain the rearward view of the vehicle 1 from being directly visually recognized via the mirror main body 52. Thus, it is possible to improve operability and restrain the rearward view from being mistakenly recognized via the mirror main body 52.

In this embodiment, the video of the rearward view displayed on the monitor 21 serving as an image output unit is reflected by the mirror 22 serving as a reflector. Thus, it is possible to increase a distance between the eye-point of the driver D and the monitor 21 (focal distance F of the driver D obtained when the driver views the rear viewing device 3), as compared to a configuration in which the monitor 21 is directly visually recognized. Thus, it is possible to reduce a difference between a focal distance obtained when the driver D views the rearward view of the vehicle 1 via the rear viewing device 3 and a focal distance obtained when the driver D views outside of the vehicle. Therefore, it is possible to reduce time to perform focus adjustment of the driver D caused by viewpoint movement of the driver D. As a result, it is possible to reduce a burden on the eyes of the driver D.

This embodiment is configured to have the divided screen mode in which the video 21a of the rearward view is displayed on the upper half portion of the monitor 21 and the whole screen mode in which the video 21c of the rearward view is displayed on the whole screen of the monitor 21.

With this configuration, in a case where the existing monitor 21 having an aspect ratio of 16:9 is used, the divided screen mode is set in a range other than the reverse position (R), and therefore it is possible to display the video of the rearward view at an aspect ratio equivalent to that of an existing mirror (mirror whose longitudinal direction is the vehicle width direction). Thus, it is possible to reduce discomfort of the driver D while reducing costs.

On the contrary, when the whole screen mode is set in a case where the range is in the reverse position (R), a wide range of the rearward view of the vehicle 1 including the area near the rear portion of the vehicle 1 can be visually recognized when the vehicle 1 moves backward.

In addition, in this embodiment, an upper half portion of a video of the rearward view captured by the rear camera 2 is displayed in the divided screen mode, and the whole video of the rearward view is displayed in the whole screen mode. That is, it is possible to switch between the divided screen mode and the whole screen mode by adding or deleting a lower half portion of the video of the rearward view captured by the rear camera 2. Therefore, it is possible to restrain reduction in visibility caused by switching of the modes, as compared to a configuration in which the whole video displayed on the monitor 21 is switched at the time of switching between the divided screen mode and the whole screen mode.

Furthermore, the video in each mode can be captured by a single rear camera 2 installed in the rear portion of the vehicle 1. Therefore, it is unnecessary to install a plurality of rear cameras in accordance with each mode and change an angle and position of the single rear camera in accordance with each mode. Thus, it is possible to simplify the configuration.

Furthermore, in this embodiment, both the monitor 21 and the mirror 22 are stored in the housing 23 and are unitized. Therefore, it is unnecessary to adjust a relative position of the monitor 21 and the mirror 22 at the time of attachment to the vehicle 1. It is therefore possible to improve assemblability of the rear viewing device 3 into the vehicle 1. Note that at least the mirror 22 only needs to be stored in the housing 23.

### Second Embodiment

A second embodiment of the present invention will be described. This embodiment is different from the above-mentioned first embodiment in that storage portions 110 and 111 of a front camera 103 and an in-vehicle camera 104 are provided in a housing 101 of a rear viewing device 100. Note that, in the following description, configurations similar to the configurations in the above-mentioned first embodiment are denoted by the same reference sign and description thereof will be omitted in some cases.

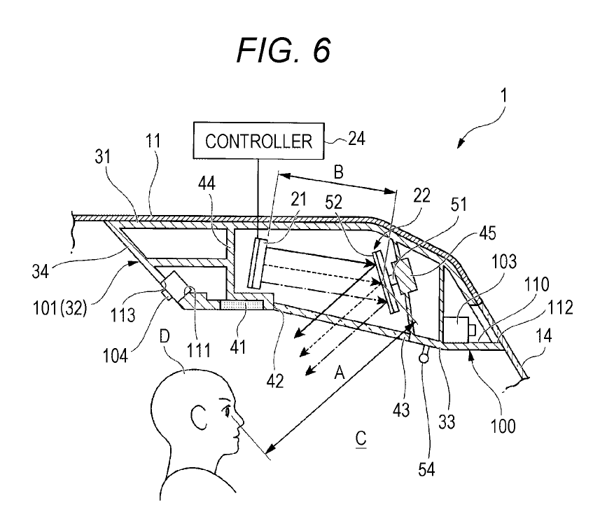

FIG. 6 is a cross-sectional view of the rear viewing device according to the second embodiment.

In the rear viewing device 100 illustrated in FIG. 6, the front camera storage portion 110 storing the front camera 103 is provided in a front portion of the housing 101. The front camera storage portion 110 is open forward through a penetration hole 112 provided in the front end portion of the attachment wall portion 31. The front camera 103 is held in the front camera storage portion 110 and captures an image of a front area of the vehicle 1 through the windshield 14.

The in-vehicle camera storage portion 111 storing the in-vehicle camera 104 is provided in a rear portion of the housing 101. The in-vehicle camera storage portion 111 is open in a diagonally downward and backward direction through a penetration hole 113 provided in the rear wall portion 34. The in-vehicle camera 104 is held in the in-vehicle camera storage portion 111 and captures an image of the interior C of the vehicle.

This configuration has effects similar to those of the first embodiment. Furthermore, not only the monitor 21 and the mirror 22 but also the front camera 103 and the in-vehicle camera 104 can be unitized as the rear viewing device 100.

Hereinabove, the embodiments of the present invention have been described in detail with reference to the drawings. However, a specific configuration is not limited to those embodiments and encompasses, for example, design variation within the scope of the present invention.

For example, in the above-mentioned embodiments, a case where the rear viewing devices 3 and 100 are provided separately from the roof 11 has been described. However, the embodiments are not limited thereto, and the rear viewing devices 3 and 100 may be integrally provided with the roof 11. Further, the rear viewing devices 3 and 100 may be configured to be embedded in the roof 11. In this case, the roof 11 itself forms a storage portion.

In the configuration described in the above-mentioned embodiments, a plane mirror is used as the mirror 22. However, the mirror 22 is not limited thereto. For example, the mirror 22 having a concave (curved in both a longitudinal cross-sectional view in the vertical direction and a lateral cross-sectional view in the vehicle width direction) reflection surface may be employed. With this configuration, it is possible to increase an apparent distance between the mirror 22 and the monitor 21 obtained when the driver D views the mirror 22, as compared to an actual distance. Thus, it is possible to reduce a difference between a focal distance obtained when the driver D views a rearward view via the rear viewing devices 3 and 100 and a focal distance obtained when the driver D views outside of the vehicle. Therefore, it is possible to reduce time to perform focus adjustment of the driver D caused by viewpoint movement of the driver D. As a result, it is possible to reduce a burden on the eyes of the driver D. Note that it is only necessary that an image of at least one of the longitudinal cross-sectional view in the vertical direction and the lateral cross-sectional view in the vehicle width direction is provided on a concave surface.

In the above-mentioned embodiments, a case of using the monitor 21 and the mirror 22 having an aspect ratio of 16:9 have been described. However, the embodiments are not limited thereto, and it is possible to appropriately vary a design of the aspect ratio of the monitor 21 and the mirror 22. In this case, for example, a monitor and mirror having an aspect ratio equivalent to an aspect ratio of an existing mirror may be used.

Note that a variable mechanism for adjusting the distance A between the monitor 21 and the mirror 22 may be provided based on a physique, a riding posture, and the like of the driver D.

In the configurations described in the above-mentioned embodiments, the lens 43 is provided in the opening 42. However, the lens 43 may not need to be provided. In this case, the angle of the mirror main body 52 may be directly adjusted through the opening 42.

In the configurations described in the above-mentioned embodiments, the divided screen mode and the whole screen mode are switched in accordance with the range of the automatic transmission. The embodiments are not limited thereto, and one of the divided screen mode and the whole screen mode may be displayed at all times. Further, in the configurations described in the above-mentioned embodiments, the vehicle information 21b is displayed on the lower half portion of the monitor 21 in the divided screen mode. However, a video may not need to be displayed on the lower half portion of the monitor 21.

In the configurations described in the above-mentioned embodiments, the divided screen mode and the whole screen mode are switched by switching a video displayed on the monitor 21. Each mode may be switched by switching a reflection range of the mirror main body 52. That is, only a part of a video displayed on the monitor 21, which is incident on an upper half portion of the reflection surface of the mirror main body 52, may be reflected in the divided screen mode, and the video displayed on the monitor 21 may be reflected by the whole reflection surface of the mirror main body 52 in the whole screen mode.

In the configurations described in the above-mentioned embodiments, the monitor 21 is used as the image output unit and the mirror 22 is used as the reflector. However, the embodiments are not limited thereto. For example, a projector for projecting a video of a rearward view captured by the rear camera 2 may be used as the image output unit, and a reflective screen for reflecting an image of the rearward view projected from the projector may be used as the reflector.

In addition, it is possible to appropriately replace constituent elements in the above-mentioned embodiments with well-known constituent elements within the gist of the present invention.

### DESCRIPTION OF REFERENCE SIGNS

1 . . . vehicle
2 . . . rear camera (image capturing unit)
3, 100 . . . rear viewing device
11 . . . roof
21 . . . monitor (image output unit)
22 . . . mirror (reflector)
23, 101 . . . housing (storage portion)
42 . . . opening

1. A rear viewing device, comprising:
an image output unit configured to output an image of a rearward view of a vehicle captured by an image capturing unit;
a reflector configured to reflect the image of the rearward view output from the image output unit; and
a storage portion provided on a roof of an interior of the vehicle and storing at least the reflector, wherein
the storage portion has an opening for emitting the image of the rearward view reflected by the reflector toward the interior of the vehicle.

2. The rear viewing device according to claim 1, wherein
the storage portion blocks a space between the reflector and a rear panel of the vehicle.

3. The rear viewing device according to claim 1, wherein
the image output unit is a monitor for displaying the image of the rearward view, and
the reflector is a mirror for reflecting the image of the rearward view displayed on the image output unit.

4. The rear viewing device according to claim 1, wherein
the image output unit is stored in the storage portion together with the reflector.

5. The rear viewing device according to claim 1, wherein
the reflector has a concave reflection surface.

6. The rear viewing device according to claim 1, wherein
the rear viewing device has
a divided screen mode in which the image of the rearward view is displayed on an upper portion of the reflector or the image output unit, and
a whole screen mode in which the image of the rearward view is displayed on the whole reflector or the whole image output unit.
